(19) United States
(12) Patent Application Publication
(10) Pub. No.: US 2014/0256277 A1
(43) Pub. Date: Sep. 11, 2014

(54) EQUALIZER-BASED RECEIVER IN MOBILE COMMUNICATION SYSTEM AND METHOD FOR RECEIVING SIGNAL USING THE SAME

(71) Applicant: Samsung Electronics Co. Ltd., Suwon-si (KR)

(72) Inventors: Young-Min KI, Yongin-si (KR); Min-Ho SHIN, Seongnam-si (KR); Il-Muk CHOI, Suwon-si (KR)

(73) Assignee: Samsung Electronics Co. Ltd., Suwon-si (KR)

(21) Appl. No.: 13/951,923

(22) Filed: Jul. 26, 2013

(30) Foreign Application Priority Data
Mar. 11, 2013 (KR) 10-2013-0025718

(51) Int. Cl. H04B 1/10; H04L 27/01

(52) U.S. Cl. CPC H04B 1/10; H04L 27/01
USPC 455/296

(57) ABSTRACT

A method for receiving a signal using an equalizer-based receiver is provided. The method includes compensating for a phase offset of a received signal for each of M cells, and performing channel estimation on the phase offset-compensated received signal for each of the M cells, compensating for an inter-cell timing offset in a channel estimate for each of the M cells, reconstructing an interference component of a reference signal using the compensated channel estimate for each of the M cells, regenerating a phase offset difference between the serving cell and each of the multiple interfering cells for each of the M cells, adding the phase offset difference to the interference component of a reference signal for each of the M cells, cancelling, from the received signal, the interference component of a reference signal with the phase offset for each of the M cells, and equalizing the interference component-cancelled received signal.

### PRIORITY

This application claims the benefit under 35 U.S.C. §119(a) of a Korean patent application filed on Mar. 11, 2013 in the Korean Intellectual Property Office and assigned Serial No. 10-2013-0025718, the entire disclosure of which is hereby incorporated by reference.

### BACKGROUND OF THE INVENTION

1. Field of the Invention

The present invention relates to an equalizer-based receiver in a mobile communication system and a method for receiving signals using the same. More particularly, the present invention relates to an equalizer-based receiver for cancelling interferences between cells by compensating for phase and timing offsets in the field environments where there are phase and timing offsets between multiple cells including a serving cell and a plurality of interfering cells in a mobile communication system, and a method for receiving signals using the same.

2. Description of the Related Art

With the ongoing standardization and commercialization of high-speed mobile communication systems such as Wideband Code Division Multiple Access (WCDMA) and High-Speed Downlink Packet Access (HSDPA), equalizer-based receivers suitable for high-speed reception have been researched and developed in many different ways.

The core structure of the equalizer-based receiver lies in the algorithm of a channel estimator having a tap long enough to receive all delay profiles of the received signals that have experienced the multi-path environment, and an adaptive equalizer that uses the estimated multi-tap channel values.

In the field environments where there are multiple cells, the phase and timing of each cell interference signal is observed to be unstable in a specific direction. Nevertheless, the equalizer-based receiver does not consider the field environments where inter-cell interference signals are observed to be unstable in terms of phase and timing. Therefore, the performance gain may be lower than the theoretical estimate of the performance gain.

For example, the equalizer-based receiver is designed on the assumption that inter-cell interference signals will have no phase offset. In the field environments, however, the Doppler size and direction of each cell are observed at random as base stations use different oscillators and a receiving terminal moves between the base stations.

In these environments, thanks to Radio Frequency (RF) control, the equalizer-based receiver can cancel the phase offset of received signals for the serving cell. However, its channel estimation for the interfering cells decreases in accuracy due to the presence of relative phase offsets for the interfering cells, causing degradation of reception performance.

In addition, signals from base stations in the field may have different timing shifts and timing offsets because the base stations have different oscillators and the terminal moves between the base stations.

In particular, the timing offset, which is less than or equal to the sampling clock of the receiver system, cannot be controlled. For example, in an equalizer-based receiver that is implemented with a 2× chip clock, if serving cell signals and interfering-cell signals have timing shifts in different directions, the received signals from the serving cell and received signals from the interfering cells may have a sampling clock difference of ¼ chip, ⅛ chip and the like, which is an interval less than the half chip.

However, the equalizer-based receiver performs half-chip timing control. Accordingly, in the presence of the sampling clock difference of ¼ chip, ⅛ chip and the like, the sampling clock obtained by performing channel estimation for the interfering cells may not be matched, causing a loss of performance, especially a loss of performance in an interference signal generator of the equalizer-based receiver.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide an equalizer-based receiver for estimating phase and timing offsets for each cell and compensating for the estimated phase and timing offsets during the equalizer-based receiver's signal reception in the actual field environments where there are random phase and timing offsets between cells in a mobile communication system, and a method for receiving signals using the same.

In accordance with an aspect of the present invention, a method for receiving a signal using an equalizer-based receiver in a communication environment in which a phase offset and a timing offset exist between cells is provided. The method includes one serving cell and (M−1) interfering cells, where M is greater than or equal to 2. The method includes compensating for a phase offset of a received signal received for each of M cells, performing channel estimation on the phase offset-compensated received signal for each of the M cells, compensating for an inter-cell timing offset in the channel estimate for each of the M cells, constructing an interference component of a reference signal using the compensated channel estimate for each of the M cells, generating a phase offset difference between the serving cell and each of the multiple interfering cells for each of the M cells, adding the phase offset difference to the interference component of a reference signal for each of the M cells, cancelling, from a received signal of a serving cell, the interference component of the reference signal with the phase offset for each of the M cells, and equalizing the interference component-cancelled received signal using a predetermined filter coefficient.

In accordance with another aspect of the present invention, an equalizer-based receiver for receiving a signal in a communication environment in which a phase offset and a timing offset exists between cells is provided. The equalizer-based receiver includes one serving cell and (M−1) interfering cells, where M is greater than or equal to 2. The equalizer-based receiver includes a multi-cell phase offset compensator for compensating for a phase offset of a received signal received, for each of M cells, a multi-cell channel estimator for performing channel estimation on the phase offset-compensated received signal for each of the M cells, a multi-cell timing offset compensator for compensating for an inter-cell timing offset in the channel estimate for each of the M cells, a multi-cell reference signal reconstructor for reconstructing an interference component of a reference signal using the inter-cell timing offset-compensated channel estimate for each of the M cells, a multi-cell phase offset regenerator for regenerating a phase offset difference between the serving cell and each of the multiple interfering cells and for adding the phase offset difference to the interference component of a reference signal for each of the M cells, a reference signal canceller for cancelling the interference component of a reference signal with the phase offset difference from the phase offset-compensated received signal, and an equalizer Finite Impulse Response (FIR) filter for equalizing the interference component-cancelled received signal using a predetermined filter coefficient.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating an equalizer-based receiver with multi-cell Signal Reconstruct Least Mean Square (SRE-LMS) and reference signal cancellation according to an exemplary embodiment of the present invention;

FIG. 2 is a block diagram illustrating internal structures of a multi-cell channel estimator and a multi-cell PN generator, such as the multi-cell channel estimator and the multi-cell PN generator illustrated in FIG. 1, according to an exemplary embodiment of the present invention;

FIG. 3 is a block diagram of a multi-cell equalizer adaptation unit, such as the multi-cell equalizer adaptation unit illustrated in FIG. 1, according to an exemplary embodiment of the present invention;

FIG. 4 is a block diagram of a multi-cell reference signal reconstructor and a reference signal canceller, such as the multi-cell reference signal reconstructor and the reference signal canceller illustrated in FIG. 1, according to an exemplary embodiment of the present invention;

FIG. 5 is a block diagram illustrating internal structures of an equalizer-based receiver with multi-cell SRE-LMS and reference signal cancellation using phase and timing offset compensation according to an exemplary embodiment of the present invention;

FIG. 6 is a block diagram illustrating internal structures of a multi-cell phase offset compensator, a multi-cell channel estimator and a multi-cell PN generator, such as the multi-cell phase offset compensator, the multi-cell channel estimator and the multi-cell PN generator illustrated in FIG. 5, according to an exemplary embodiment of the present invention;

FIG. 7 illustrates a phase rotator, such as the phase rotator illustrated in FIG. 6, according to an exemplary embodiment of the present invention;

FIG. 8 is a block diagram internal structures of a multi-cell timing offset compensator, a reference signal canceller and a multi-cell phase offset regenerator, such as the multi-cell timing offset compensator, the reference signal canceller and the multi-cell phase offset regenerator illustrated in FIG. 5, according to an exemplary embodiment of the present invention;

FIG. 9 illustrates input samples and output samples of a N-times interpolator, such as the N-times interpolator illustrated in FIG. 8, according to an exemplary embodiment of the present invention;

FIG. 10 illustrates input samples and output samples of a (N:1) path selector, such as the (N:1) path selector illustrated in FIG. 8, according to an exemplary embodiment of the present invention; and

FIG. 11 is a block diagram illustrating internal structures of a multi-cell phase and timing offset controller, such as the multi-cell phase and timing offset controller illustrated in FIG. 5, according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skilled in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

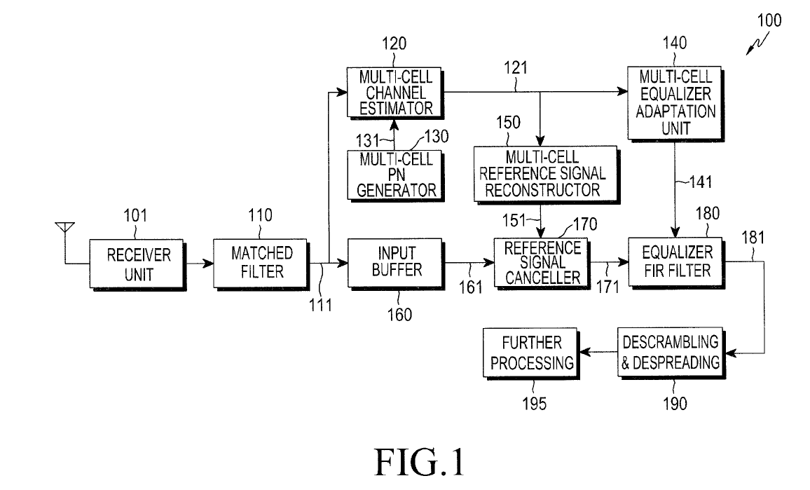

FIG. 1 is a block diagram illustrating an equalizer-based receiver with multi-cell Signal Reconstruct Least Mean Square (SRE-LMS) and reference signal cancellation according to an exemplary embodiment of the present invention.

Referring to FIG. 1, the equalizer-based receiver 100 includes an antenna ANT, a receiver unit 101, a matched filter 110, a multi-cell channel estimator 120, a multi-cell PN generator 130, a multi-cell equalizer adaptation unit 140, a multi-cell reference signal reconstructor 150, an input buffer 160, a reference signal canceller 170, an equalizer Finite Impulse Response (FIR) filter 180, and a descrambling and despreading unit 190.

The matched filter 110 provides a received chip signal to the multi-cell channel estimator 120 and the input buffer 160.

The multi-cell channel estimator 120 is configured to generate a multi-cell channel estimate 121 by performing channel estimation for its own cell (or serving cell) and multiple other cells. A channel estimate for each cell includes channel estimates for Nₜₐₚ consecutive taps. In order to perform channel estimation for multiple cells, the multi-cell PN generator 130 is required for demodulation of a pilot channel of each cell.

The multi-cell PN generator 130 generates a unique Pseudo-random Noise (PN) code corresponding to each cell.

The multi-cell equalizer adaptation unit 140 generates an equalizer FIR filter tap coefficient 141 using the multi-cell channel estimate received from the multi-cell channel estimator 120, and provides the generated equalizer FIR filter tap coefficient 141 to the equalizer FIR filter 180.

The multi-cell reference signal reconstructor 150 reconstructs a multi-cell reference signal interference component 151 using the multi-cell channel estimate 121 and a reference signal pattern.

The reference signal canceller 170 cancels the multi-cell reference signal interference component 151 from the input signal 161 received via the input buffer 160, and provides the results to the equalizer FIR filter 180.

A signal 181 that has passed the equalizer FIR filter 180 is converted into a symbol-level signal after undergoing descrambling and despreading in the descrambling and despreading unit 190, and then undergoes further processing 195 (for example, demodulation processing).

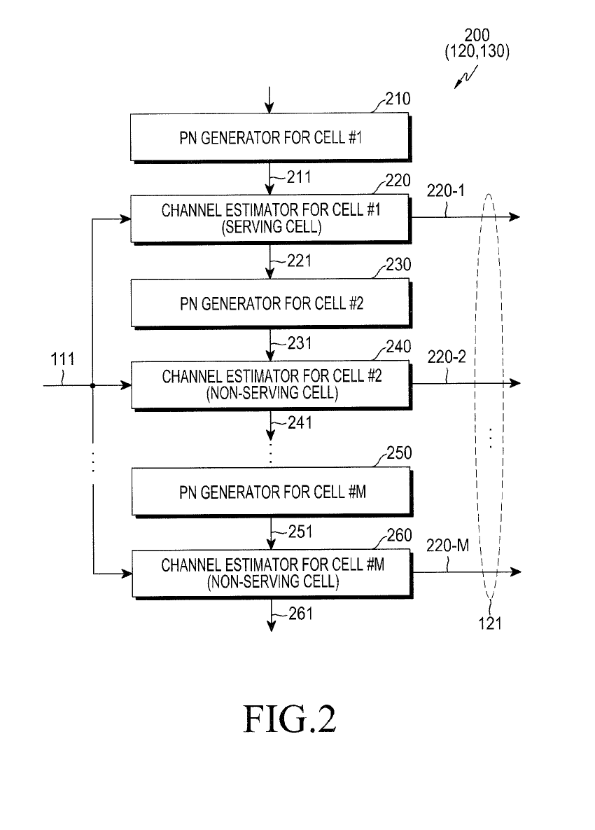

FIG. 2 is a block diagram illustrating internal structures of a multi-cell channel estimator and a multi-cell PN generator 200, such as the multi-cell channel estimator and the multi-cell PN generator illustrated in FIG. 1, according to an exemplary embodiment of the present invention.

Referring to FIG. 2, the multi-cell channel estimator 120 includes M-cell channel estimators for cells #1˜#M to perform channel estimation for M cells, and the multi-cell PN generator 130 includes M-cell PN generators for cells #1˜#M, where M denotes the number of cells, a signal from each of which is received at the receiver, and information about each of which can be identified by the receiver. The M cells include the receiver's own cell (or serving cell) and interfering cells (or non-serving cells). In other words, M denotes the total number of cells and a reference signal from each of the cells can be restored by the receiver.

A first-cell PN generator (or PN generator for cell #1) 210 and a first-cell channel estimator (or channel estimator for cell #1) 220, constituting a multi-tap channel estimator for the serving cell, receive the input signal 111 from the matched filter 110, and generate a channel estimate 221 for Nₜₐₚ consecutive taps.

A second-cell PN generator (or PN generator for cell #2) 230 and a second-cell channel estimator (or channel estimator for cell #2) 240, perform channel estimation for the second cell which is an interfering cell, and then output Nₜₐₚ consecutive channel estimates 241.

In the same way, an M^{-th}-cell PN generator (or PN generator for cell #M) 250 and an M^{-th}-cell channel estimator (or channel estimator for cell #M) 260, perform channel estimation for the M-th cell which is an interfering cell, and then Nₜₐₚ consecutive channel estimates 261.

A PN generator exists for each cell because each cell generates a unique PN code since each cell has a unique IDentification (ID) for its own PN code and has a unique transmission offset (or transmission delay time difference). The multi-cell multi-tap channel estimates 221, 241 and 261 are input to the multi-cell equalizer adaptation unit 140 in FIG. 1.

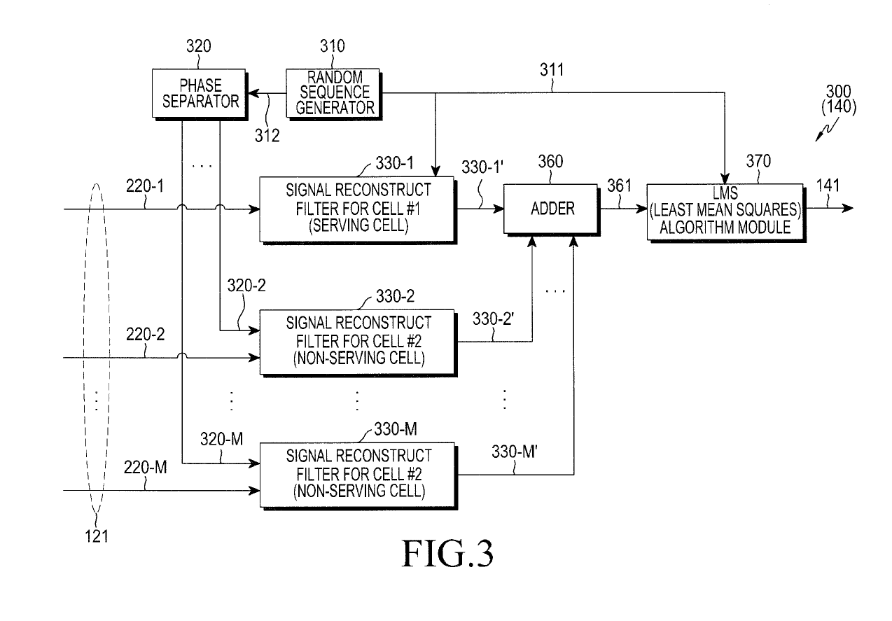

FIG. 3 is a block diagram of a multi-cell equalizer adaptation unit 300, such as the multi-cell equalizer adaptation unit illustrated in FIG. 1, according to an exemplary embodiment of the present invention.

Referring to FIG. 3, the multi-cell equalizer adaptation unit 140 (with an SRE-LMS algorithm) includes a random sequence generator 310, a phase separator 320, M-cell signal reconstruct filters for cells #1 to #M (330-1, 330-2, . . . , 330-M), an adder 360, and a Least Mean Squares (LMS) algorithm module 370.

The first-cell signal reconstruct filter 330-1 receives the multi-tap channel estimate 221 for the serving cell and a random sequence 311 from the random sequence generator 310, sets the multi-tap channel estimate 221 as an FIR filter tap coefficient, and generates a statistical random sequence 330-1′ by filtering the random sequence 311. The random sequence 311 is a random sequence with statistical characteristics that are similar to the transmission signal of the base station of the serving cell, and the statistical random sequence 330-1′ is a random sequence with statistical characteristics that are similar to the signal which is received at the terminal from the base station of the serving cell.

The phase separator 320 receives a random sequence 312 from the random sequence generator 310, and generates (M−1) random sequences having different signal phases from the random sequence 311. For example, the random sequence generator 310 may be made of a memory in which 2048-length ‘1’ and ‘−1’ are randomly mixed and stored. For the random sequence 311 to model the transmission signal of the serving cell, the phase separator 320 repeats a stored random sequence with zero (0) timing and phase offset. The phase separator 320 may model multiple random sequences having the same statistical characteristics, if it outputs a random sequence 320-2 by repeating the stored random sequence with 512 timing and phase offsets and outputs a random sequence 320-M by repeating the stored random sequence with 1024 phases.

The second-cell signal reconstruct filter 330-2 receives a multi-tap channel estimate 220-2 for the second cell, sets the multi-tap channel estimate 220-2 as an FIR filter tap coefficient, generates a statistical random sequence 330-2′ by filtering the random sequence 320-2, and provides the statistical random sequence 330-2′ to the adder 360.

In the same way, the M^{-th}-cell signal reconstruct filter 330-M receives a multi-tap channel estimate 220-M for the M-th cell, sets the multi-tap channel estimate 220-M as an FIR filter tap coefficient, generates a statistical random sequence 330-M′ by filtering the random sequence 320-M, and provides the statistical random sequence 330-M′ to the adder 360.

The random sequences 330-2′ and 330-M′ are obtained, respectively, by modeling the random sequences whose statistical characteristics are similar to that of the signals that are received at the terminal from the second cell and the M-th cell, which may be interfering cells or non-serving cells.

The adder 360 adds the statistical random sequences 330-1′, 330-2′ . . . 330-M′ and provides the addition results 361 to the LMS algorithm module 370. Therefore, the addition results 361 become a random sequence whose statistical characteristics are similar to the sequences obtained by modeling all of the signals that are received at the terminal from multiple cells in the multi-cell reception environment.

The LMS algorithm module 370 makes reference to the serving cell transmission signal for the random sequence 311 and calculates an equalizer FIR filter tap coefficient using the added random sequence 361.

The multi-cell equalizer adaptation unit 140 illustrated in FIG. 3 performs channel estimation for all the cells, reconstructs reference signals from which the receiving terminal may restore, and adds the statistical random sequences which are generated as estimated multi-cell channel estimates, thereby making it possible to model the signals having the same statistical characteristics as the multi-cell received signals. The strength of a received signal for each cell is reflected by generating a statistical random sequence for each multi-cell channel estimate.

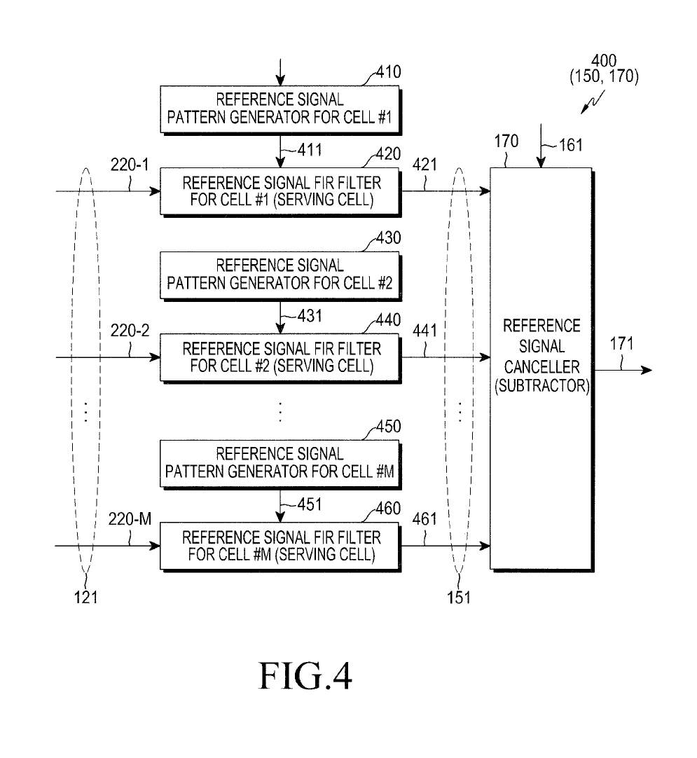

FIG. 4 is a block diagram of a multi-cell reference signal reconstructor and a reference signal canceller 400, such as the multi-cell reference signal reconstructor and the reference signal canceller illustrated in FIG. 1, according to an exemplary embodiment of the present invention.

Referring to FIG. 4, the multi-cell reference signal reconstructor 150 is configured to reconstruct multi-cell reference signals in a physical layer and cancel the multi-cell reference signals from data signals, thereby improving the quality of received signals.

The signals that the reference signal canceller 170 desires to cancel are the reference signals whose inter-channel orthogonality is not maintained and whose pattern can be generated in the physical layer. In the Wideband Code Division Multiple Access (WCDMA) and High-Speed Downlink Packet Access (HSDPA) systems, a Synchronization CHannel (SCH) of the serving cell and SCHs and Common PIlot CHannels (CPICHs) of the interfering cells correspond to the reference signals.

The SCH, which is a channel comprised of a Primary SCH (P-SCH) and a Secondary SCH (S-SCH), is a reference signal that is used for cell search purpose and can be generated in a physical layer. Since SCH is transmitted by the base station without being spread by an orthogonal code, signals from both the serving cell and other cells serve as interference in the receiver.

The CPICH, on which a Primary CPICH (P-CPICH) and a Secondary CPICH (S-CPICH) can be carried, is a reference signal that is used for channel estimation purpose and can be generated in a physical layer. Since CPICH is transmitted by the base station after being spread by an orthogonal code, a signal from the serving cell does not serve as interference in the receiver. However, signals from other cells are not cancelled in the despreading process and serve as interference in the receiver since their inter-cell timing synchronizations are not matched. A first-cell reference signal pattern generator 410 generates a reference signal 411 of the serving cell.

In the WCDMA and HSDPA systems, the reference signal 411 becomes an SCH signal pattern. A first-cell reference signal FIR filter 420 is an FIR filter that uses a first-cell multi-tap channel estimate 220-1 as its tap coefficient, and the first-cell reference signal FIR filter 420 filters the reference signal pattern 411. Therefore, a reference signal 421 is reconstructed as the almost same signal as the first-cell reference signal that has arrived at the receiver after passing through the channel.

A second-cell reference signal pattern generator 430 generates a reference signal 431 for the second cell, which is an interfering cell. In the WCDMA and HSDPA system, the reference signal 431 becomes a SCH and CPICH signal pattern. A second-cell reference signal FIR filter 440 is an FIR filter that uses a second-cell multi-tap channel estimate 441 as its tap coefficient, and the second-cell reference signal FIR filter 440 filters the reference signal pattern 431. Therefore, a reference signal 441 is reconstructed as the almost same signal as the second-cell reference signal that has arrived at the receiver after passing through the channel.

An M^{-th}-cell reference signal pattern generator 450 generates a reference signal 451 of an M-th cell which is an interfering cell. An M^{-th}-cell reference signal FIR filter 460 is an FIR filter that uses an M^{-th}-cell multi-tap channel estimate 220-M as its tap coefficient, and the M^{-th}-cell reference signal FIR filter 460 filters the reference signal pattern 451. Therefore, a reference signal 461 is reconstructed as the almost same signal as the M^{-th}-cell reference signal that has arrived at the receiver after passing through the channel.

The reference signal canceller 170 is configured to cancel the multi-cell reference signals 421, 441 and 461 from the received data signal 161 and may be implemented with a subtractor. The strength of a received signal for each cell is reflected in each multi-cell channel estimate, and the reference signal pattern generator should exist for each cell.

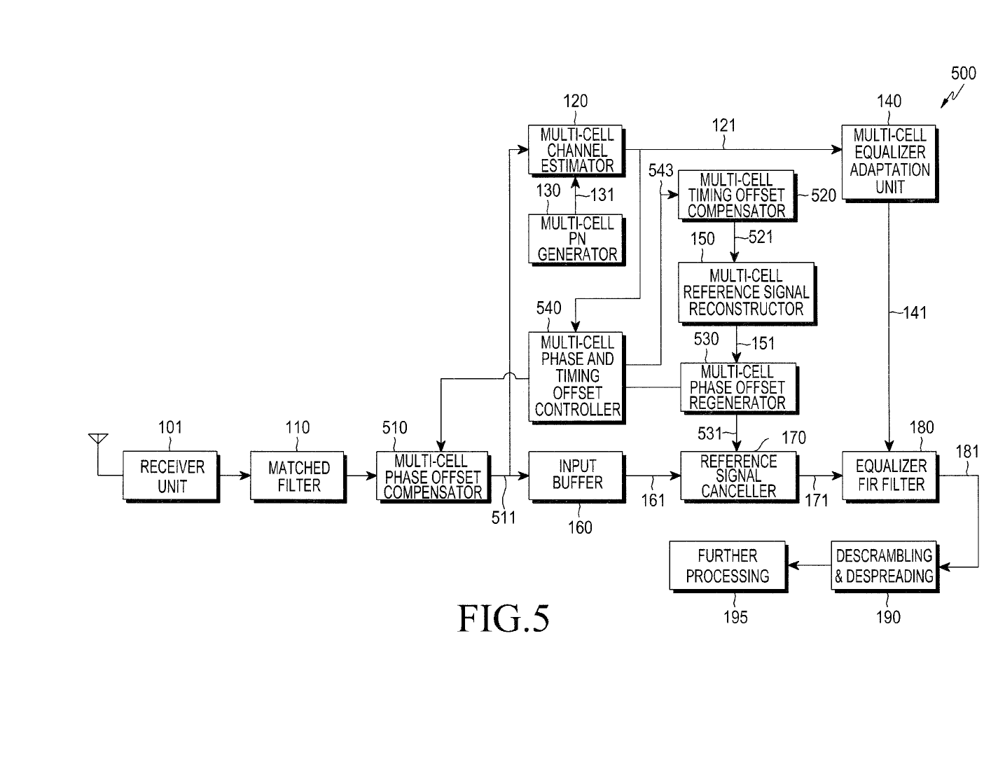

FIG. 5 is a block diagram illustrating internal structures of an equalizer-based receiver with multi-cell SRE-LMS and reference signal cancellation using phase and timing offset compensation according to an exemplary embodiment of the present invention.

Referring to FIG. 5, the equalizer-based receiver 500 includes a receive antenna ANT, a receiver unit 101, a matched filter 110, a multi-cell channel estimator 120, a multi-cell PN generator 130, a multi-cell equalizer adaptation unit 140, a multi-cell reference signal reconstructor 150, an input buffer 160, a reference signal canceller 170, and an equalizer FIR filter 180. In order to estimate and compensate for phase and timing offsets of each cell taking into account the actual multi-cell field environments where phase and timing offsets exist between cells, the equalizer-based receiver 500 further includes a multi-cell phase offset compensator 510, a multi-cell timing offset compensator 520, a multi-cell phase offset regenerator 530, and a multi-cell phase and timing offset controller 540.

The matched filter 110, the multi-cell channel estimator 120, the multi-cell PN generator 130, the multi-cell equalizer adaptation unit 140, the multi-cell reference signal reconstructor 150, the input buffer 160, the reference signal canceller 170, and the equalizer FIR filter 180 included in the equalizer-based receiver 500 are described above in connection with FIGS. 1 to 4.

The multi-cell phase offset compensator 510 compensates for a phase offset of each cell for an input chip signal received via the matched filter 110 and provides the phase offset-compensated input chip signal to the multi-cell channel estimator 120. Upon receiving the phase offset-compensated input chip signal, the multi-cell channel estimator 120 may perform channel estimation for each cell without phase offset.

The multi-cell timing offset compensator 520 compensates for an inter-cell timing offset in the multi-cell channel estimate and provides the inter-cell timing offset-compensated multi-cell channel estimate to the multi-cell reference signal reconstructor 150. Upon receiving the inter-cell timing offset-compensated multi-cell channel estimate, the multi-cell reference signal reconstructor 150 reconstructs the interference signal components at the exact timing.

The timing difference between multiple cells may be divided into timing shift and timing offset.

The timing shift refers to a direction in which a timing clock of an inter-cell received signal moves in a timing difference in units of sampling clock of the receiver system. For example, the serving cell may have a difference of one ½-chip clock in the positive direction, and the interfering cell may have a difference of two ½-chip clocks in the negative direction. In conventional methods, the difference is compensated for by performing timing advance/retard adjustment on the sampling clock.

The timing offset refers to a timing difference which is less than the system sampling clock. In other words, the timing offset is a timing difference of, for example, ¼ chip, ⅛ chip and the like. In conventional methods, the inter-cell timing offset difference causes performance degradation in the field environments since timing offset compensation was not considered. In the exemplary embodiments of the present invention, the inter-cell timing offset may be compensated for in the multi-cell channel estimates so that the multi-cell reference signal reconstructor 150 may reconstruct interference signal components at the exact timing.

The multi-cell phase offset regenerator 530 regenerates an inter-cell phase offset difference for the reconstructed multi-cell reference signal interference component 151, allowing the reference signal canceller 170 to cancel the same interference components as the received signal. As the multi-cell phase offset compensator 510 cancels the phase offset corresponding to each cell, the multi-cell channel estimation and interference signal reconstruction may be accurately achieved. However, since the actual received signal may have an inter-cell phase offset difference, the phase offset-cancelled signal may not result in interference cancellation, and the phase offset difference should be regenerated and result in interference cancellation to perform interference cancellation suitable for the received signal.

The multi-cell phase and timing offset controller 540 estimates phase and timing offsets for each cell based on the multi-cell channel estimates and provides the measurement results to the multi-cell phase compensator 510 and multi-cell timing offset compensator 520 at the appropriate time.

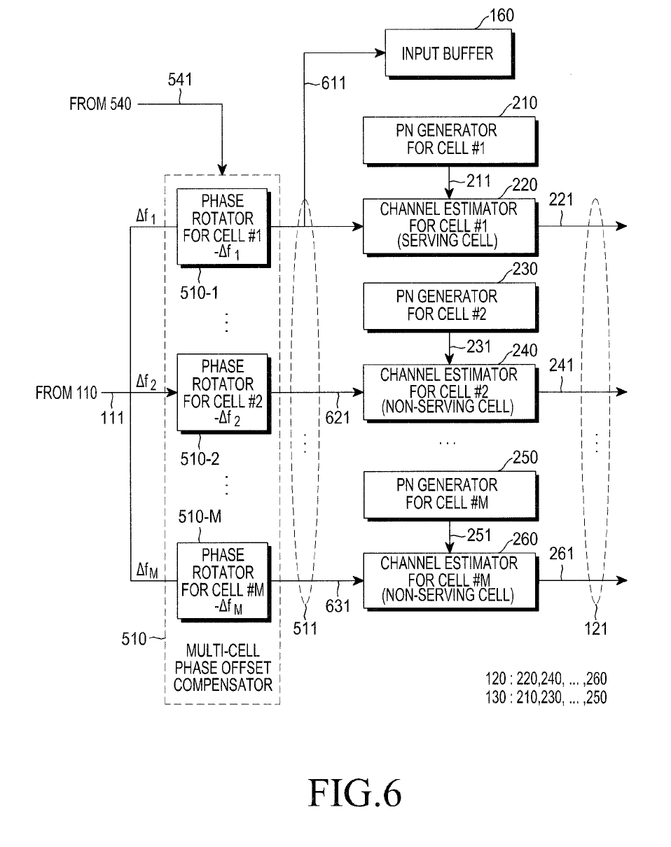

FIG. 6 is a block diagram illustrating internal structures of a multi-cell phase offset compensator, a multi-cell channel estimator and a multi-cell PN generator, such as the multi-cell phase offset compensator, the multi-cell channel estimator and the multi-cell PN generator illustrated in FIG. 5, according to an exemplary embodiment of the present invention.

Referring to FIG. 6, the multi-cell phase offset compensator 510 includes M phase rotators 510-1, 510-2 . . . 510-M, where M denotes the number of cells from which the receiver can receive signals. Each phase rotator is controlled depending on a control signal 541 from the multi-cell phase and timing offset controller 540.

A phase rotator 510-1 for the serving cell (or cell #1) outputs a phase offset-free signal 611 by performing phase compensation on the phase offset left in the received signal. The output phase offset-free signal 611 is delivered to the input buffer 160 and the serving-cell channel estimator (or channel estimator for cell #1) 220. Accordingly, the equalizer FIR filter 180 in FIG. 5 and the serving-cell channel estimator 220 may perform an equalization process on the phase offset-free serving-cell received signal.

In some cases, the serving-cell phase rotator 510-1 may not operate because a Radio Frequency (RF) Autonomous Frequency Control (AFC) unit provides a signal after compensating for its phase offset so that there is almost no phase offset Δf₁ for the serving cell. Phase rotators 510-2 to 510-M for the interfering cells (or cells #2 to #M) may compensate for the phase offsets Δf₁˜Δf_{M} of their associated interfering-cell received signals, making it possible to calculate phase offset-cancelled channel estimates for the cells.

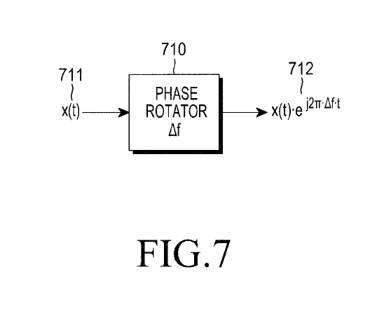

FIG. 7 illustrates a phase rotator, such as the phase rotator illustrated in FIG. 6, according to an exemplary embodiment of the present invention.

Referring to FIG. 7, the phase rotator is a circuit that generates a phase-rotated signal x(t)·e^{j2Π·Δf·t} by rotating an input signal x(t) by a phase of Δf.

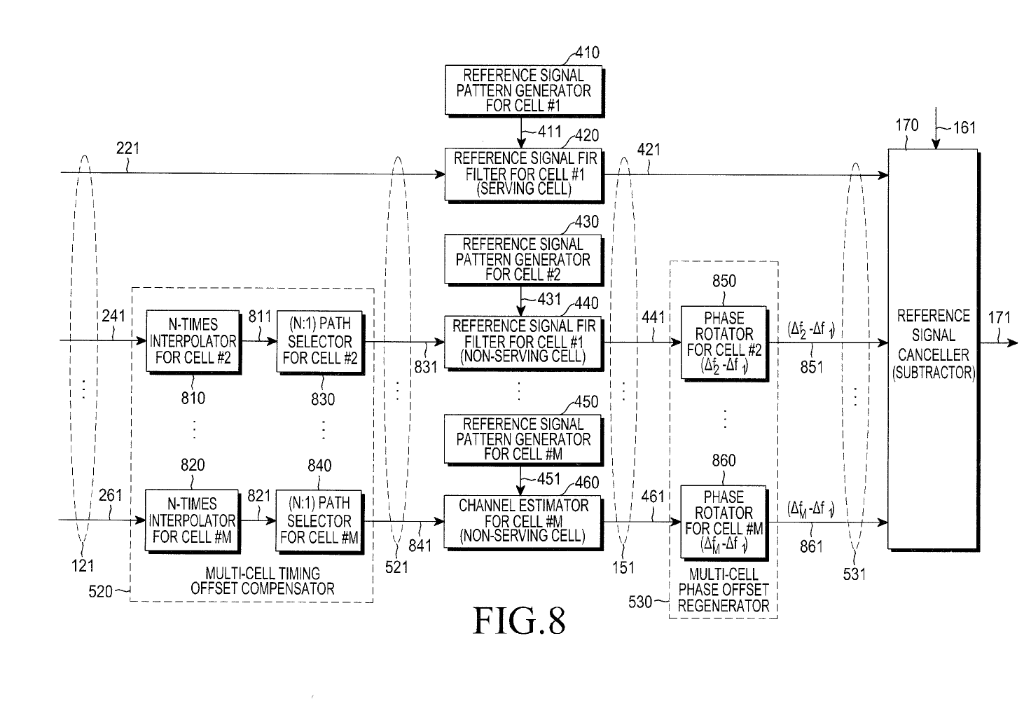

FIG. 8 is a block diagram internal structures of a multi-cell timing offset compensator, a reference signal canceller and a multi-cell phase offset regenerator, such as the multi-cell timing offset compensator, the reference signal canceller and the multi-cell phase offset regenerator illustrated in FIG. 5, according to an exemplary embodiment of the present invention.

Referring to FIG. 8, the exemplary embodiment of the present invention performs multi-cell timing offset compensation before reconstruction of multi-cell reference signal interferences and then regenerates a phase offset difference after generation of reference signals to perform reference signal cancellation. Therefore, the reference signal interferences having the substantially the same cell-specific phase and timing offsets as the received signals in the actual field environments are cancelled from the input signals, making it possible to perform the equalizer FIR filter without a loss of performance.

The multi-cell timing offset compensator 520 is applied to the interfering cells except for the serving cell.

Since the sampling clock of the receiver system is timing-controlled to maximize the signal strength of the serving cell, the residual timing offset, which is less than or equal to the sampling clock for the serving cell, does not occur under most conditions. However, for the interfering cells, the residual timing offset may occur and compensation for the interfering cells is performed by N-times interpolators and (N:1) path selectors, as illustrated in FIG. 8. For example, in the receiver system that operates with a 2× chip clock, the interfering cells may have the residual timing offset of a ¼-chip or ⅛-chip interval as compared to the serving cell.

If the multi-cell timing offset compensator 520 is operated with N=4, channel estimates of a ⅛-chip interval may be obtained by performing 4-times interpolators for the interfering-cell channel estimates, and from them, the residual timing offset-compensated interfering cell-channel estimates of a ½-chip interval may be obtained by (4:1) path selectors.

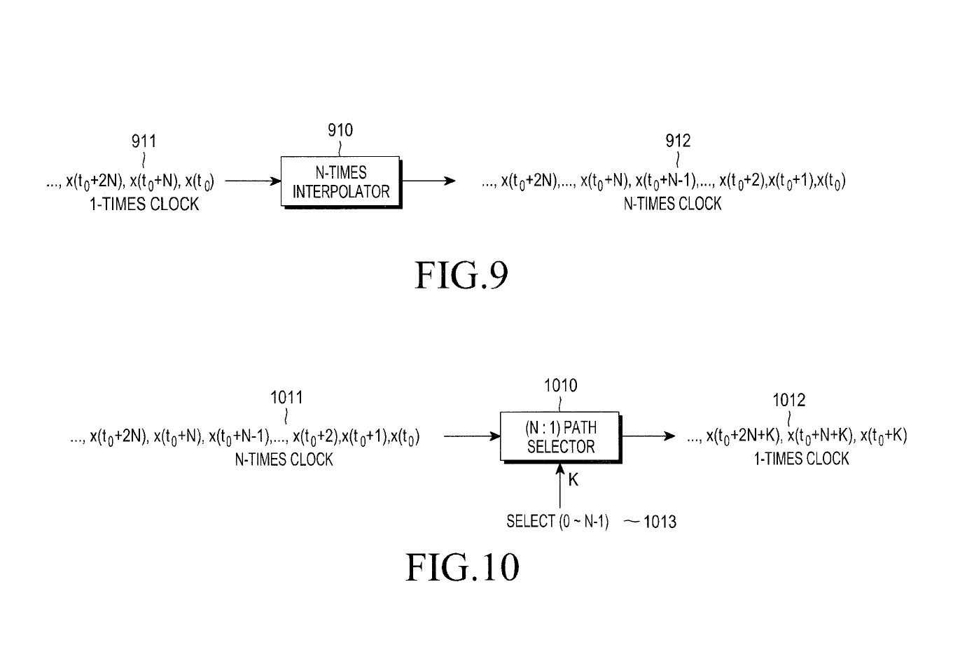

FIG. 9 illustrates input samples and output samples of a N-times interpolator, such as the N-times interpolator illustrated in FIG. 8, according to an exemplary embodiment of the present invention.

Referring to FIG. 9, an N-times interpolator 910 generates output samples 912 by additionally interpolating (N−1) samples between the input samples 911.

FIG. 10 illustrates input samples and output samples of a (N:1) path selector, such as the (N:1) path selector illustrated in FIG. 8, according to an exemplary embodiment of the present invention.

Referring to FIG. 10, an (N:1) path selector 1010, contrary to the N-times interpolator, selects only one of N consecutive samples depending on the settings of Select bits of (0˜N−1).

Referring back to FIG. 8, the multi-cell phase offset regenerator 530 is applied after creation of reference signal FIR filters.

The multi-cell phase offset regenerator 530 is applied to the interfering cells except for the serving cell. Interference signals for channel estimation are regenerated after different phase offsets of the cells are compensated for by their associated phase rotators in the multi-cell phase offset compensator 510, and for the received signal delivered through the input buffer 160, its phase offset is cancelled on the basis of the serving cell so that the phase offsets for the interfering cells remain in the form of a phase offset difference for the serving cell. Accordingly, to perform accurate interference signal cancellation, interference cancellation should be performed after the phase offset difference of interfering cells with respect to the serving cell is compensated for.

The multi-cell phase offset regenerator 530 may also be configured by applying a phase rotator to each cell signal. A phase rotator for cell #2, which is an interfering cell, generates an offset difference Δf₂−Δf₁ between the interfering cell and the serving cell, and applies it to the phase offset-free input signal 441. In other words, a regenerated interference signal 851 for cell #2 (or interfering cell) is generated as a signal having the same residual offset of Δf₂−Δf₁ as that of the received signal. In the same way, phase rotators for the other interfering cells may also generate the residual offset and deliver the residual offset to the reference signal canceller 170 and then output the signal for further processing 171.

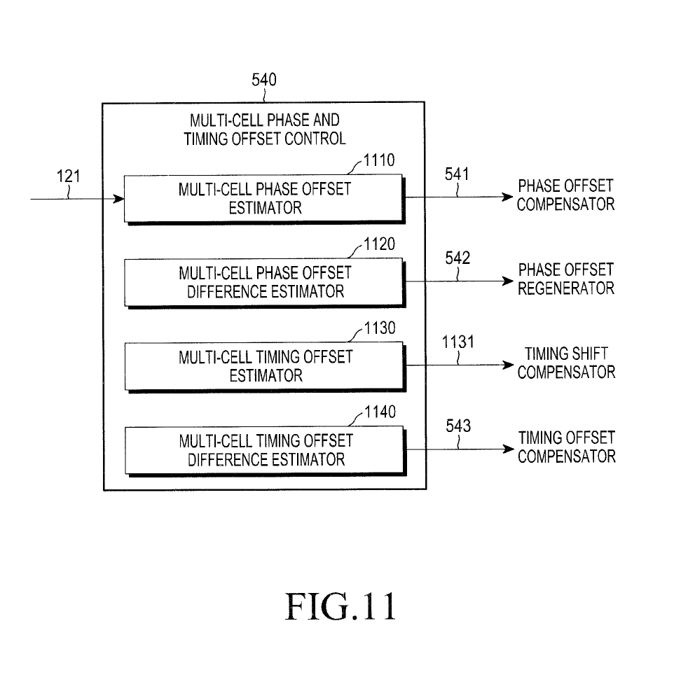

FIG. 11 is a block diagram illustrating internal structures of a multi-cell phase and timing offset controller, such as the multi-cell phase and timing offset controller illustrated in FIG. 5, according to an exemplary embodiment of the present invention.

Referring to FIG. 11, the multi-cell phase and timing offset controller 540 includes a multi-cell phase offset estimator 1110, a multi-cell phase offset difference estimator 1120, a multi-cell timing offset estimator 1130 and a multi-cell timing offset difference estimator 1140.

The estimators 1110, 1120, 1130 and 1140 estimate timing and phase offsets for each cell to control their associated compensators. For estimation of the timing and phase offsets for each cell, the estimators 1110, 1120, 1130 and 1140 require the multi-cell channel estimate 121 as an input.

Based on the channel estimate for each cell, the multi-cell phase offset estimator 1110 estimates a phase offset for each cell, and controls each phase offset compensator using the output 541.

The multi-cell phase offset difference estimator 1120 calculates a phase offset difference between the serving cell and the interfering cells, and then controls the phase offset regenerator using the output 542.

Based on the channel estimate for each cell, the multi-cell timing offset estimator 1130 calculates a timing shift for each cell, and controls each timing shift compensator using the output 1131.

The multi-cell timing offset difference estimator 1140 calculates residual timing offsets of interfering cells, and then controls the timing offset compensator using the output 543.

In the field environments, the inter-cell received signals are received with different random phase and timing offsets due to the difference in oscillator of the base stations and the difference in Doppler of the receiving terminals.

The exemplary embodiments of the present invention may estimate the phase and timing offsets of inter-cell received signals and compensate for the estimated phase and timing offsets, making it possible to provide high-speed reception performance without the loss of performance even in the multi-cell field environments.

As is apparent from the foregoing description, the equalizer-based receiver according to exemplary embodiments of the present invention may estimate phase and timing offsets for each cell and compensate for the estimated phase and timing offsets, taking into account the multi-cell environments in which phase and timing offsets exist between cells, thus allowing the receiver to provide the performance gain even in multi-cell field environments, thereby providing high-speed reception performance.

While the invention has been shown and described with reference to certain exemplary embodiments thereof, it will be understood by those skilled in the art that various changes in form and details may be made therein without departing from the spirit and scope of the invention as defined by the appended claims and their equivalents.

1. A method for receiving a signal using an equalizer-based receiver in a communication environment in which a phase offset and a timing offset exist between cells including one serving cell and (M−1) interfering cells, where M is greater than or equal to 2, the method comprising:
compensating for a phase offset of a received signal received for each of M cells;
performing channel estimation on the phase offset-compensated received signal for each of the M cells;
compensating for an inter-cell timing offset in the channel estimate for each of the M cells;
reconstructing an interference component of a reference signal using the compensated channel estimate for each of the M cells;
regenerating a phase offset difference between the serving cell and each of the interfering cells for each of the M cells;
adding the phase offset difference to the interference component of the reference signal for each of the M cells;
cancelling, from a received signal from a serving cell, the interference component of the reference signal with the phase offset for each of the M cells; and
equalizing the interference component-cancelled received signal using an equalizer filter coefficient.

2. The method of claim 1, wherein the performing of the channel estimation comprises compensating for the phase offset of the received signal using M phase rotators for each of the M cells.

3. The method of claim 1, wherein the received signal of the serving cell is a signal which has undergone matched-filtering.

4. The method of claim 1, wherein the compensating for the inter-cell timing offset comprises compensating for a timing offset between the interfering cells except for the serving cell.

5. The method of claim 4, wherein the compensating for the inter-cell timing offset comprises:
if the equalizer-based receiver operates with an N-times chip clock, performing interpolation to generate output samples obtained by adding (N−1) samples between input samples; and
selecting one of N consecutive samples among the output samples, and outputting the selected one sample as the timing offset-compensated results.

6. The method of claim 1, wherein the regenerating of the phase offset comprises:
calculating a phase offset difference between each of the (M−1) interfering cells and the serving cell by using (M−1) phase rotators; and
adding the calculated phase offset difference to the interference component of the reference signal.

7. The method of claim 6, generating the equalizer filter coefficient from the channel estimate using a Least Mean Squares algorithm.

8. An equalizer-based receiver for receiving a signal in a communication environment in which a phase offset and a timing offset exist between cells including one serving cell and (M−1) interfering cells, where M is greater than or equal to 2, the receiver comprising:
a multi-cell phase offset compensator for compensating for a phase offset of a received signal received via an antenna for each of M cells;
a multi-cell channel estimator for performing channel estimation on the phase offset-compensated received signal for each of the M cells;
a multi-cell timing offset compensator for compensating for an inter-cell timing offset in the channel estimate for each of the M cells;
a multi-cell reference signal reconstructor for reconstructing an interference component of a reference signal using the inter-cell timing offset-compensated channel estimate for each of the M cells;
a multi-cell phase offset regenerator for regenerating a phase offset difference between the serving cell and each of the multiple interfering cells and for adding the phase offset difference to the interference component of a reference signal for each of the M cells;
a reference signal canceller for cancelling the interference component of a reference signal with the phase offset difference from the phase offset-compensated received signal; and
an equalizer Finite Impulse Response (FIR) filter for equalizing the interference component-cancelled received signal using an equalizer filter coefficient.

9. The equalizer-based receiver of claim 8, further comprising a matched filter for matched-filtering the received signal received via the antenna, wherein the multi-cell phase offset compensator compensates for a phase offset of the matched-filtered received signal, for each of the M cells, and provides the phase offset-compensated received signal to the multi-cell channel estimator and the reference signal canceller.

10. The equalizer-based receiver of claim 8, wherein the multi-cell phase offset compensator includes M phase rotators, and compensates for the phase offset of the received signal for each of the M cells.

11. The equalizer-based receiver of claim 8, wherein the multi-cell reference signal reconstructor compensates for a timing offset between the interfering cells except for the serving cell.

12. The equalizer-based receiver of claim 11, wherein the multi-cell phase offset compensator includes (M−1) phase rotators, each of which rotates a phase based on a phase offset difference between a related interfering cell and the serving cell.

13. The equalizer-based receiver of claim 8, wherein the multi-cell timing offset compensator compensates for a timing offset between the interfering cells except for the serving cell.

14. The equalizer-based receiver of claim 13, wherein, if the equalizer-based receiver operates with an N-times chip clock, the multi-cell timing offset compensator comprises:
(M−1) interpolators for generating output samples obtained by adding (N−1) samples between input samples; and
(M−1) path selectors, each of which receives the output samples, selects one of N consecutive samples among the output samples, and outputs the selected one sample as the timing offset-compensated results.

15. The equalizer-based receiver of claim 8, wherein the multi-cell phase offset regenerator includes (M−1) phase rotators, each of which rotates a phase depending on a phase offset difference between each of the (M−1) interfering cells and the serving cell.

16. The equalizer-based receiver of claim 8, further comprising for generating the equalizer filter coefficient from the channel estimate using a Least Mean Squares algorithm.

17. At least one non-transitory processor readable medium for storing a computer program of instructions configured to be readable by at least one processor for instructing the at least one processor to execute a computer process for performing the method as recited in claim 1.
